(19) United States
(12) Patent Application Publication
(10) Pub. No.: US 2011/0019641 A1
(43) Pub. Date: Jan. 27, 2011

(54) MOBILE NODE, WiMAX BASE STATION, Wi-Fi ACCESS POINT AND HANDOVER METHOD THEREOF FOR USE IN A HETEROGENEOUS WIRELESS NETWORK SYSTEM

(75) Inventors: Chia-Hsiang CHANG, Taipei City (TW); Chih-Peng HSU, Taipei County (TW); Chih-Hsiang HO, Taipei City (TW); Heng-Iang HSU, Taipei City (TW); I-Hung LIN, Taipei City (TW)

Correspondence Address: DAVID H BEAM, PO BOX 623, FOREST RANCH, CA, 95942, US

(73) Assignee: INSTITUTE FOR INFORMATION INDUSTRY, Taipei (TW)

(21) Appl. No.: 12/578,350

(22) Filed: Oct. 13, 2009

(30) Foreign Application Priority Data
Jul. 22, 2009 (TW) 098124702

(51) Int. Cl. H04W 36/00

(52) U.S. Cl. 370/331

(57) ABSTRACT

A mobile node (MN), a WiMAX base station (BS), a Wi-Fi access point (AP) and a handover method therefore, for use in a heterogeneous wireless network system, are provided. The heterogeneous wireless network system comprises a gateway. The WiMAX BS and the Wi-Fi AP can interchange messages with each other via the gateway. There is an overlap service area between the WiMAX BS and the Wi-Fi AP. The MN accepts a network service, which is provided by the gateway, via the WiMAX BS. When the MN enters the overlap service area, it may handover to the Wi-Fi AP without interrupting the network service so that the gateway may provide the network service for the MN via the Wi-Fi AP.

This application claims priority to Taiwan Patent Application No. 098124702 filed on Jul. 22, 2009.

### CROSS-REFERENCES TO RELATED APPLICATIONS

Not applicable.

### BACKGROUND OF THE INVENTION

1. Field of the Invention

The present invention relates to a mobile node, a WiMAX base station, a Wi-Fi access point and a handover method thereof for use in a heterogeneous wireless network system. More specifically, the present invention relates to a mobile node, a WiMAX base station, a Wi-Fi access point and a handover method thereof that support a seamless handover in a heterogeneous wireless network system.

2. Descriptions of the Related Art

Network use has become more prevalent, as seen in online shopping, online banking, network real-time video conferencing and the like. For purposes of higher flexibility and convenience when using network services, a variety of wireless network specifications have been developed.

According to the coverage range, wireless networks are generally classified into wireless wide area networks (WANs), wireless local area networks (LANs) and wireless private networks (PNs). To implement the concept of “last mile” connection in network services, replacement of expensive wired LANs with wireless LANs has become a trend for future networks, and as a kind of wireless WAN technology, WiMAX has been developed under this concept. On the other hand, wireless LANs mainly rely on the use of gradually matured Wi-Fi technology.

However, in terms of the current development tendency and the frequency of use, although WiMAX has advantages of a high speed and a wide coverage range, Wi-Fi still has the advantage of more stable connection qualities in wireless LANs. Therefore, when a mobile node is going to enter a Wi-Fi network from a WiMAX network it is originally connected to, it may still choose, according to the quality of service (QoS) it desires, to switch from the WiMAX network to the Wi-Fi network and receive network services via the Wi-Fi network.

Furthermore, a mobile node tends to move about with its user in practicality. Therefore, to maintain a certain level of communication quality, it is likely that the mobile node will switch among various heterogeneous networks, e.g., from a WiMAX network to a Wi-Fi network. However, for current mobile nodes, they usually begin a handover to the next network (e.g., the Wi-Fi network) only when they fail to receive signals from the previous network (e.g., the WiMAX network), which will definitely cause an interruption of network services currently received by the mobile nodes and consequently affect the quality of the network services.

Accordingly, it is important to allow a mobile node to handover seamlessly between a WiMAX wireless network and a Wi-Fi wireless network.

### SUMMARY OF THE INVENTION

An objective of the present invention is to provide a mobile node for use in a heterogeneous wireless network system. The heterogeneous wireless network system comprises a gateway, a Wi-Fi wireless network and a Worldwide Interoperability for Microwave Access (WiMAX) wireless network. The Wi-Fi wireless network comprises a Wi-Fi access point. The WiMAX wireless network comprises a WiMAX base station. The WiMAX base station is adapted to exchange messages with the Wi-Fi access point via the gateway. The WiMAX base station and the Wi-Fi access point have an overlap service area together. The mobile node is currently receiving a network service provided by the gateway via the WiMAX base station. The mobile node comprises: a storage module, configured to store connection information related to the WiMAX base station; a WiMAX wireless network interface, configured to receive the network service; a Wi-Fi wireless network interface; and a process module, configured to determine that the mobile node has entered the overlap service area to generate a determination result. The Wi-Fi wireless network interface is configured to, according to the determination result, transmit a link request signal to the Wi-Fi access point to establish a link of a data link layer with the Wi-Fi access point immediately and, via the link, transmit the connection information and a first handover request signal to the Wi-Fi access point. The WiMAX base station, the Wi-Fi access point and the gateway are adapted to jointly perform a handover procedure according to the connection information, the first handover request signal and a media independent handover protocol so that the network service is provided by the gateway to the mobile node via the Wi-Fi access point. The Wi-Fi wireless network interface is further configured to receive the network service in place of the WiMAX wireless network interface.

Another objective of the present invention is to provide a handover method for a mobile node in a heterogeneous wireless network system. The mobile node comprises a process module, a WiMAX wireless network interface, a Wi-Fi wireless network interface, and a storage module. The heterogeneous wireless network system comprises a gateway, a WiMAX wireless network and a Wi-Fi wireless network. The WiMAX wireless network comprises a WiMAX base station. The Wi-Fi wireless network comprises a Wi-Fi access point. The WiMAX base station is adapted to exchange messages with the Wi-Fi access point via the gateway. The WiMAX base station and the Wi-Fi access point have an overlap service area together. The mobile node is currently receiving a network service provided by the gateway via the WiMAX base station. The storage module of the mobile node stores connection information related to the WiMAX base station. The handover method comprises the following steps: (a) enabling the process module to determine that the mobile node has entered the overlap service area to generate a determination result; (b) enabling the Wi-Fi wireless network interface to, according to the determination result, transmit a link request signal to the Wi-Fi access point to establish a link of a data link layer with the Wi-Fi access point immediately; and (c) enabling the Wi-Fi wireless network interface to transmit the connection information and a first handover request signal to the Wi-Fi access point via the link. The WiMAX base station, the Wi-Fi access point and the gateway are adapted to jointly perform a handover procedure according to the connection information, the first handover request signal and a media independent handover protocol so that the network service is provided by the gateway to the mobile node via the Wi-Fi access point.

A further objective of the present invention is to provide a mobile node for use in a heterogeneous wireless network system. The heterogeneous wireless network system comprises a gateway, a Wi-Fi wireless network and a WiMAX wireless network. The Wi-Fi wireless network comprises a Wi-Fi access point. The WiMAX wireless network comprises a WiMAX base station. The WiMAX base station is adapted to exchange messages with the Wi-Fi access point via the gateway. The WiMAX base station and the Wi-Fi access point have an overlap service area. The mobile node is currently receiving a network service provided by the gateway via the Wi-Fi access point. The mobile node comprises: a storage module, configured to store connection information related to the Wi-Fi access point; a WiMAX wireless network interface; a Wi-Fi wireless network interface, configured to receive the network service; and a process module, configured to determine that the mobile node has entered the overlap service area to generate a determination result. The Wimax wireless network interface is configured to, according to the determination result, transmit a link request signal to the WiMAX base station to establish a link of a data link layer with the WiMAX base station immediately and, via the link, transmit the connection information and a first handover request signal to the WiMAX base station. The WiMAX base station, the Wi-Fi access point and the gateway are adapted to jointly perform a handover procedure according to the connection information, the first handover request signal and a media independent handover protocol so that the network service is provided by the gateway via the WiMAX base station. The WiMAX wireless network interface is further configured to receive the network service in place of the Wi-Fi wireless network interface.

Yet another objective of the present invention is to provide a handover method for a mobile node in a heterogeneous wireless network system. The mobile node comprises a process module, a WiMAX wireless network interface, a Wi-Fi wireless network interface, and a storage module. The heterogeneous wireless network system comprises a gateway, a WiMAX wireless network and a Wi-Fi wireless network. The WiMAX wireless network comprises a WiMAX base station. The Wi-Fi wireless network comprises a Wi-Fi access point. The WiMAX base station is adapted to exchange messages with the Wi-Fi access point via the gateway. The WiMAX base station and the Wi-Fi access point have an overlap service area together. The mobile node is currently receiving a network service provided by the gateway via the Wi-Fi access point. The storage module of the mobile node stores connection information related to the Wi-Fi access point. The handover method comprises the following steps: (a) enabling the process module to determine that the mobile node has entered the overlap service area to generate a determination result; (b) enabling the WiMAX wireless network interface to, according to the determination result, transmit a link request signal to the WiMAX base station to establish a link of a data link layer with the WiMAX base station immediately; and (c) enabling the WiMAX wireless network interface to transmit the connection information and a first handover request signal respectively to the WiMAX base station via the link. The WiMAX base station, the Wi-Fi access point and the gateway are adapted to jointly perform a handover procedure according to the connection information, the first handover request signal and a media independent handover protocol so that the network service is provided by the gateway to the mobile node via the WiMAX base station.

Still another objective of the present invention is to provide a Wi-Fi access point for use in a heterogeneous wireless network system. The heterogeneous wireless network system comprises a mobile node, a gateway, a Wi-Fi wireless network and a WiMAX wireless network. The Wi-Fi wireless network comprises the Wi-Fi access point. The WiMAX wireless network comprises a WiMAX base station. The Wi-Fi access point is linked to the gateway via a wired network. The WiMAX base station is adapted to exchange messages with the Wi-Fi access point via the gateway. The WiMAX base station and the Wi-Fi access point have an overlap service area together. The mobile node is currently receiving a network service provided by the gateway via the WiMAX base station, and when the mobile node just enters the overlap service area, it transmits a link request signal, connection information related to the WiMAX base station and a first handover request signal in sequence. The Wi-Fi access point comprises: a storage module, configured to store handover information related to the Wi-Fi access point; a WiMAX wireless network interface; a Wi-Fi wireless network interface, configured to receive the link request signal, establish a link of a data link layer with the mobile node according to the link request signal, and receive the connection information and the first handover request signal in sequence via the link; a wired network interface, compatible with the wired network and configured to connect to the gateway via the wired network; and a process module, configured to compose the connection information and the handover information according to the first handover request signal to generate composition information. The wired network interface is further configured to transmit the first handover request signal and the composition information to the gateway via the wired network so that the gateway, the WiMAX wireless network interface and the WiMAX base station jointly perform a handover procedure according to the first handover request signal, the composition information and a media independent handover protocol. Upon completion of the handover procedure, the network service is provided by the gateway to the mobile node via the Wi-Fi wireless network interface of the Wi-Fi access point.

Yet another objective of the present invention is to provide a handover method for a Wi-Fi access point. The Wi-Fi access point is adapted for use in a heterogeneous wireless network system. The Wi-Fi access point comprises a storage module, a WiMAX wireless network interface, a Wi-Fi wireless network interface, a wired network interface and a process module. The heterogeneous wireless network system comprises a mobile node, a gateway, a Wi-Fi wireless network and a WiMAX wireless network. The Wi-Fi wireless network comprises the Wi-Fi access point. The WiMAX wireless network comprises a WiMAX base station. The wired network interface of the Wi-Fi access point is linked to the gateway via a wired network. The WiMAX base station is adapted to exchange messages with the Wi-Fi access point via the gateway. The WiMAX base station and the Wi-Fi access point have an overlap service area together. The storage module stores handover information related to the Wi-Fi access point. The mobile node is currently receiving a network service provided by the gateway via the WiMAX base station, and when the mobile node just enters the overlap service area, it transmits a link request signal, connection information related to the WiMAX base station and a first handover request signal in sequence. The handover method comprises the following steps: (a) enabling the Wi-Fi wireless network interface to receive the link request signal; (b) enabling the Wi-Fi wireless network interface to establish a link of a data link layer with the mobile node according to the link request signal; (c) enabling the Wi-Fi wireless network interface to receive the first handover request signal and the connection information in sequence from the mobile node via the link; (d) enabling the process module to compose the connection information and the handover information according to the first handover request signal to generate composition information; and (e) enabling the wired network interface to transmit the first handover request signal and the composition information to the gateway via the wired network so that the gateway, the WiMAX wireless network interface and the WiMAX base station jointly perform a handover procedure according to the first handover request signal, the composition information and a media independent handover protocol. Upon completion of the handover procedure, the network service is provided by the gateway to the mobile node via the Wi-Fi wireless network interface of the Wi-Fi access point.

Still a further objective of the present invention is to provide a WiMAX base station for use in a heterogeneous wireless network system. The heterogeneous wireless network system comprises a mobile node, a gateway, a Wi-Fi wireless network and a WiMAX wireless network. The Wi-Fi wireless network comprises a Wi-Fi access point, and the WiMAX wireless network comprises the WiMAX base station. The WiMAX base station is linked to the gateway via a wired network. The Wi-Fi access point is adapted to exchange messages with the WiMAX base station via the gateway, and the WiMAX base station and the Wi-Fi access point have an overlap service area together. The mobile node is currently receiving a network service provided by the gateway via the Wi-Fi access point, and when the mobile node just enters the overlap service area, it transmits a link request signal, connection information related to the Wi-Fi access point and a first handover request signal in sequence. The WiMAX base station comprises: a storage module, configured to store handover information related to the WiMAX base station; a WiMAX wireless network interface, configured to receive the link request signal, establish a link of a data link layer with the mobile node according to the link request signal, and receive the connection information and the first handover request signal in sequence via the link; a Wi-Fi wireless network interface; a wired network interface, compatible with the wired network and configured to connect to the gateway via the wired network; and a process module, configured to compose the connection information and the handover information according to the first handover request signal to generate composition information. The wired network interface is further configured to transmit the first handover request signal and the composition information to the gateway via the wired network so that the gateway, the Wi-Fi wireless network interface and the Wi-Fi access point jointly perform a handover procedure according to the first handover request signal, the composition information and a media independent handover protocol. Upon completion of the handover procedure, the network service is provided by the gateway to the mobile node via the WiMAX wireless network interface of the WiMAX base station.

Yet another objective of the present invention is to provide a handover method for a WiMAX base station. The WiMAX base station is adapted for use in a heterogeneous wireless network system. The WiMAX base station comprises a storage module, a WiMAX wireless network interface, a Wi-Fi wireless network interface, a wired network interface and a process module. The storage module stores handover information related to the WiMAX base station, and the heterogeneous wireless network system comprises a mobile node, a Wi-Fi access point and a gateway. The wired network interface of the WiMAX base station is linked to the gateway via a wired network, and the Wi-Fi access point and the WiMAX base station have an overlap service area together. The mobile node is currently receiving a network service provided by the gateway via the Wi-Fi access point, and when the mobile node just enters the overlap service area, it transmits a link request signal, connection information related to the Wi-Fi access point and a first handover request signal in sequence. The handover method comprises the following steps: (a) enabling the WiMAX wireless network interface to receive the link request signal; (b) enabling the WiMAX wireless network interface to establish a link of a data link layer with the mobile node according to the link request signal; (c) enabling the WiMAX wireless network interface to receive the first handover request signal and the connection information in sequence from the mobile node via the link; (d) enabling the process module to compose the connection information and the handover information according to the first handover request signal to generate composition information; and (e) enabling the wired network interface to transmit the first handover request signal and the composition information to the gateway via the wired network so that the gateway, the Wi-Fi wireless network interface and the Wi-Fi access point jointly perform a handover procedure according to the first handover request signal, the composition information and a media independent handover protocol. Upon completion of the handover procedure, the network service is provided by the gateway to the mobile node via the WiMAX wireless network interface of the WiMAX base station.

According to the above descriptions, when the mobile node of the present invention enters the overlap service area between the WiMAX network and the Wi-Fi network from the WiMAX network service area, a connection is established immediately between the mobile node and the Wi-Fi access point so that the gateway handovers the mobile node from the WiMAX base station to the Wi-Fi access point without interrupting the original service. Furthermore, the connection between the mobile node and the WiMAX base station is still kept by the Wi-Fi access point so that once the mobile node attempts to switch back to the WiMAX network, it may switch back to the WiMAX network promptly without interruption to the network service. Similarly, when the mobile node attempts to switch from the Wi-Fi network to the WiMAX network, a handover procedure can also be performed as described above. In this way, the defects of the prior art in which network services have to be interrupted during the handover of the mobile node is prevented, thereby improving the quality of network services.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a heterogeneous wireless network system according to a first embodiment of the present invention;

FIG. 2 is a schematic view illustrating exchange of handover signals in the first embodiment of the present invention;

FIG. 3 is a schematic view of a mobile node according to the first embodiment of the present invention;

FIG. 4 is a schematic view of a Wi-Fi access point according to the first embodiment of the present invention;

FIG. 5 is a schematic view of another heterogeneous wireless network system according to the first embodiment of the present invention;

FIG. 6 is a schematic view of yet another heterogeneous wireless network system according to the first embodiment of the present invention;

FIG. 7 is a schematic view of a heterogeneous wireless network system according to a second embodiment of the present invention;

FIG. 8 is a schematic view illustrating the exchange of handover signals in the second embodiment of the present invention;

FIG. 9 is a schematic view of a mobile node according to the second embodiment of the present invention;

FIG. 10 is a schematic view of a WiMAX base station according to the second embodiment of the present invention;

FIG. 11 is a schematic view of another heterogeneous wireless network system according to the second embodiment of the present invention;

FIG. 12 is a schematic view of yet another heterogeneous wireless network system according to the second embodiment of the present invention;

FIGS. 13A-13C are flowcharts according to a third embodiment of the present invention; and

FIGS. 14A-14C are flowcharts according to a fourth embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purposes of illustration rather than to limit the present invention. It should be noted that in the following embodiments and the drawings, elements unrelated to the present invention are omitted from depiction; and dimensional relationships among individual elements in the attached drawings are illustrated only for ease of understanding, but not to limit the actual scale.

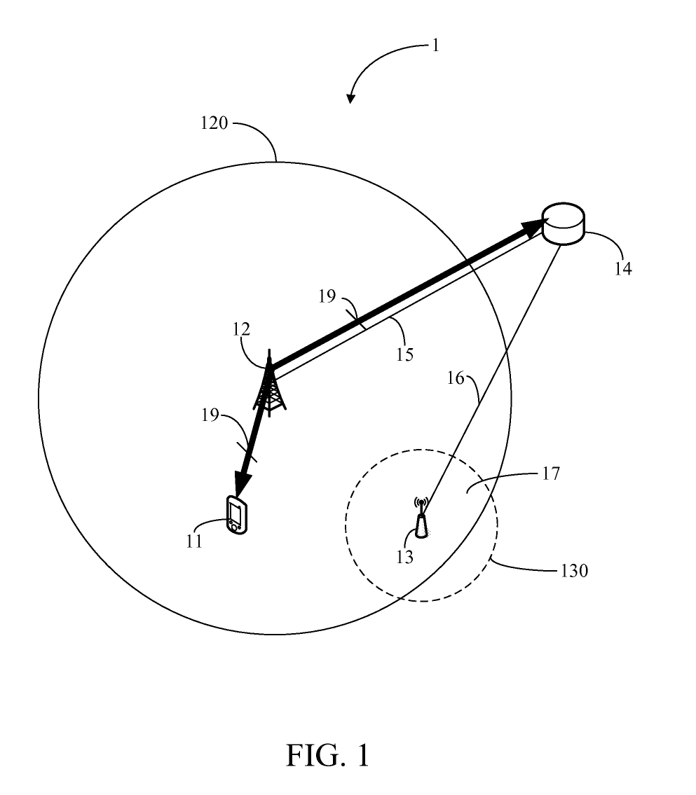

Before describing the first embodiment of the present invention, the environment in which the first embodiment of the present invention operates will be described. FIG. 1 illustrates a schematic view of a heterogeneous wireless network system 1. The heterogeneous wireless network system 1 comprises a mobile node 11, a WiMAX base station 12, a Wi-Fi access point 13 and a gateway 14. The WiMAX base station 12 and the Wi-Fi access point 13 are connected to the gateway 14 via a wired network 15 and a wired network 16 respectively, and can exchange messages with each other via the gateway 14. As shown in FIG. 1, the WiMAX base station 12 has a base station service area 120, the Wi-Fi access point 13 has an access point service area 130, and the base station service area 120 and the access point service area 130 have an overlap service area 17 together. The mobile node 11 is located within the base station service area 120 to receive a network service 19 provided by the gateway 14 via the WiMAX base station 12. Currently, the mobile node 11 is moving towards the access point service area 130.

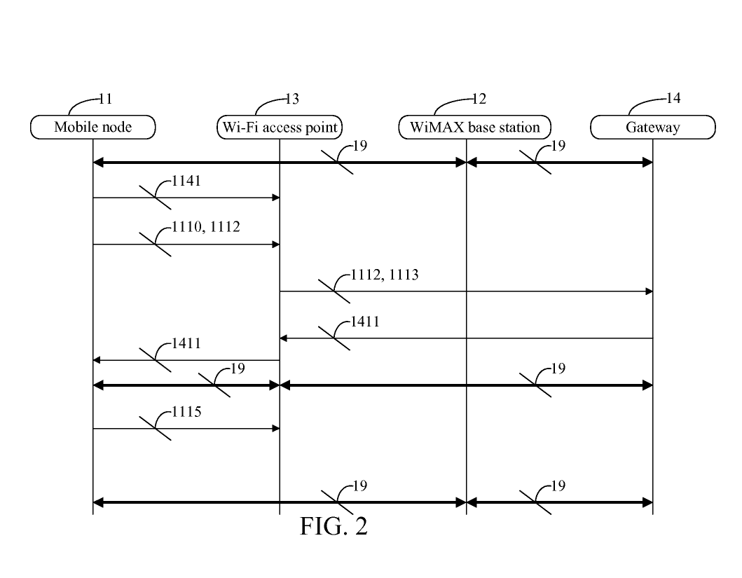

The first embodiment of the present invention is shown in FIG. 2, which is a schematic view illustrating the exchange of handover signals. As described above, the mobile node 11 is currently moving towards the access point service area 130. During this process, the mobile node 11 gradually moves away from the base station service area 120 into the access point service area 130. To ensure a certain level of communication quality during the moving process of the mobile node 11, the exchange of handover signals as shown in FIG. 2 will take place in the heterogeneous wireless network system 1 when the mobile node 11 enters the overlap service area 17.

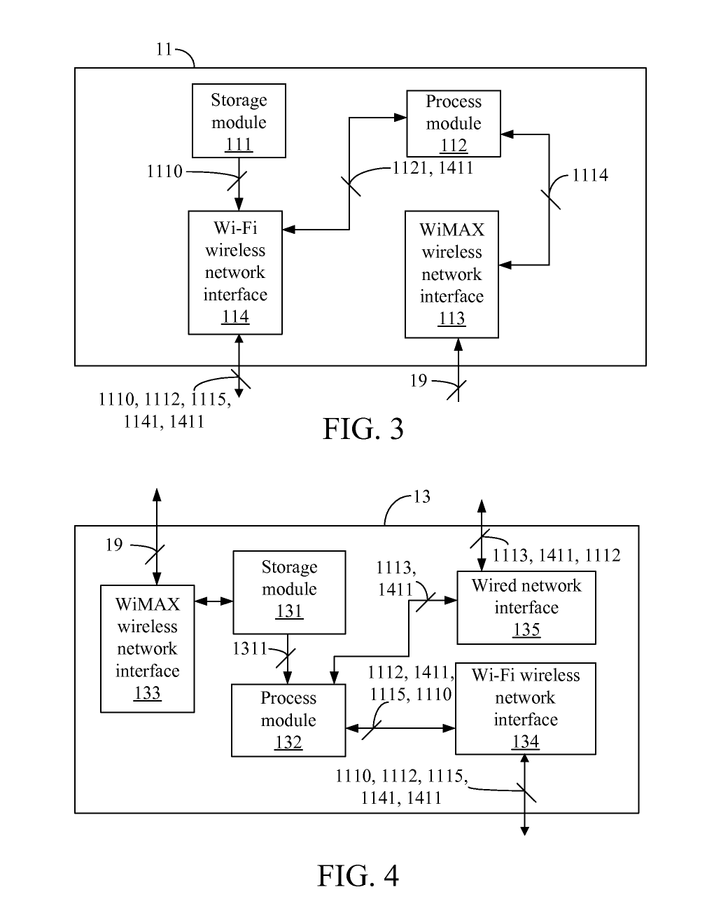

To more clearly explain actions of the mobile node 11, the WiMAX base station 12, the Wi-Fi access point 13 and the gateway 14 in exchange of handover signals in FIG. 2, reference is made to FIGS. 3 and 4, which are schematic views of the mobile node 11 and the Wi-Fi access point 13 respectively. As can be seen from FIG. 3, the mobile node 11 comprises a storage module 111, a process module 112, a WiMAX wireless network interface 113 and a Wi-Fi wireless network interface 114, in which the storage module 111 is configured to store handover information 1110 related to the WiMAX base station 12.

As can be further seen from FIG. 4, the Wi-Fi access point 13 comprises a storage module 131, a process module 132, a WiMAX wireless network interface 133, a Wi-Fi wireless network interface 134 and a wired network interface 135, in which the storage module 131 is configured to store handover information 1311 related to the Wi-Fi access point 13. The wired network interface 135 is compatible with the wired network 16, and is adapted to be connected to the gateway 14 via the wired network 16. It should be noted that both the WiMAX wireless network interfaces 113 and 133 are compatible with IEEE 802.16, while both the Wi-Fi wireless network interface 114 and 134 are compatible with IEEE 802.11. Next, the individual modules in the mobile node 11 and the Wi-Fi access point 13 as well as the operations and functions of the network interfaces and the WiMAX base station 12 will be described in detail.

First, in references to FIGS. 2-4, before the mobile node 11 enters the overlap service area 17, the WiMAX wireless network interface 113 of the mobile node 11 receives the network service 19 from the gateway 14 via the WiMAX base station 12, and the storage module 111 of the mobile node 11 stores connection information 1110 related to the WiMAX base station 12.

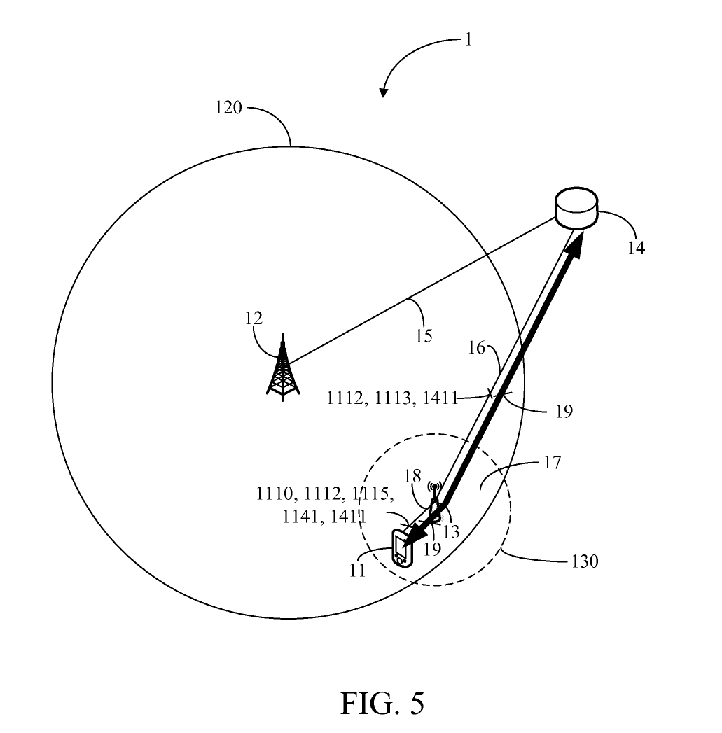

Then, as shown in FIG. 5, the mobile node 11 moves to the overlap service area 17, at which moment the process module 112 of the mobile node 11 determines that the mobile node 11 has entered the overlap service area 17 to generate a determination result 1121 immediately. According to the determination result 1121, the Wi-Fi wireless network interface 114 of the mobile node 11 transmits a link request signal 1141 to the Wi-Fi access point 13. The link request signal 1141 is received by the Wi-Fi wireless network interface 134 of the Wi-Fi access point 13, which immediately establishes a link 18 of a data link layer with the mobile node 11 according to the link request signal 1141.

After the establishment of the link 18 of the data link layer, the mobile node 11 determines whether to be handover from the WiMAX base station 12 to the Wi-Fi access point 13 upon status of the environment it currently stays in. The method in which the mobile node 11 determines whether to be handover can be accomplished by conventional technologies and will not be further described herein. To highlight the efficacy of the present invention, it will be assumed in the following description that the mobile node 11 attempts to handover. To accomplish the handover, the Wi-Fi wireless network interface 114 of the mobile node 11 transmits the connection information 1110 and the first handover request signal 1112 to the Wi-Fi access point 13 respectively via the link 18 to inform the Wi-Fi access point 13 of the information about the connection between the mobile node 11 and the WiMAX base station 12 (i.e. the connection information 1110) and that the mobile node 11 attempts to handover. It should be noted that at this point, the mobile node 11 still receives the network service 19 via the WiMAX base station 12 instead of network service interruption due to the establishment of the link 18 with the Wi-Fi access point 13.

After being transmitted by the mobile node 11, the connection information 1110 and the first handover request signal 1112 are received by the Wi-Fi wireless network interface 134 of the Wi-Fi access point 13 via the link 18, and according to the first handover request signal 1112, the process module 132 of the Wi-Fi access point 13 composes the connection information 1110 and the handover information 1311 stored in the storage module 131 to generate composition information 1113. Then, the first handover request signal 1112 and the composition information 1113 are transmitted together to the gateway 14 by the wired network module 135 of the Wi-Fi access point 13 via the wired network 16.

After the gateway 14 receives the first handover request signal 1112 and the composition information 1113, a handover procedure can be performed jointly by the gateway 14, the WiMAX wireless network interface 133 of the Wi-Fi access point 13 and the WiMAX base station 12 according to the first handover request signal 1112, the composition information 1113 and a media independent handover protocol to handover the mobile node 11 from the WiMAX base station 12 to the Wi-Fi access point 13. Consequently, upon completion of the handover procedure, the network service 19 can be provided to the mobile node 11 by the gateway 14 via the Wi-Fi wireless network interface 134 of the Wi-Fi access point 13. This handover procedure can be accomplished by a conventional technology and, thus, will not be further described herein.

Upon completion of the handover procedure, a handover response signal 1411 is transmitted by the gateway 14 to the Wi-Fi access point 13 via the wired network 16 so that the Wi-Fi access point 13 assures that the gateway 14 agrees to perform and has already performed the handover procedure. Then, a frame synchronization procedure is performed between the Wi-Fi access point 13 and the WiMAX base station 12 via the gateway 14. In more detail, in the frame synchronization procedure, the service is synchronized in the Wi-Fi access point 13 according to the service provided by the WiMAX base station 12 to the mobile node 11 so that after synchronization, the WiMAX base station 12 can be replaced by the Wi-Fi access point 13 without asynchronization of the network service 19 caused by the handover.

Upon completion of the frame synchronization, the process module 132 of the Wi-Fi access point 13 still keeps a connection (not shown) between the WiMAX base station 12 and the mobile node 11 according to the handover response signal 1411. The Wi-Fi wireless network interface 134 of the Wi-Fi access point 13 transmits the handover response signal 1411 to the mobile node 11. The handover response signal 1411 is received by the Wi-Fi wireless network interface 114 of the mobile node 11 which then, according to the handover response signal 1411, receives the network service 19 via the Wi-Fi access point 13 as shown in FIG. 5. Furthermore, according to the handover response signal 1411, the process module 112 of the mobile node 11 determines that the aforesaid handover procedure has been completed to generate a sleep signal 1114. Then, the WiMAX wireless network interface 113 of the mobile node 11 enters a sleep mode according to the sleep signal 1114 to reduce power consumption of the WiMAX wireless network interface 113.

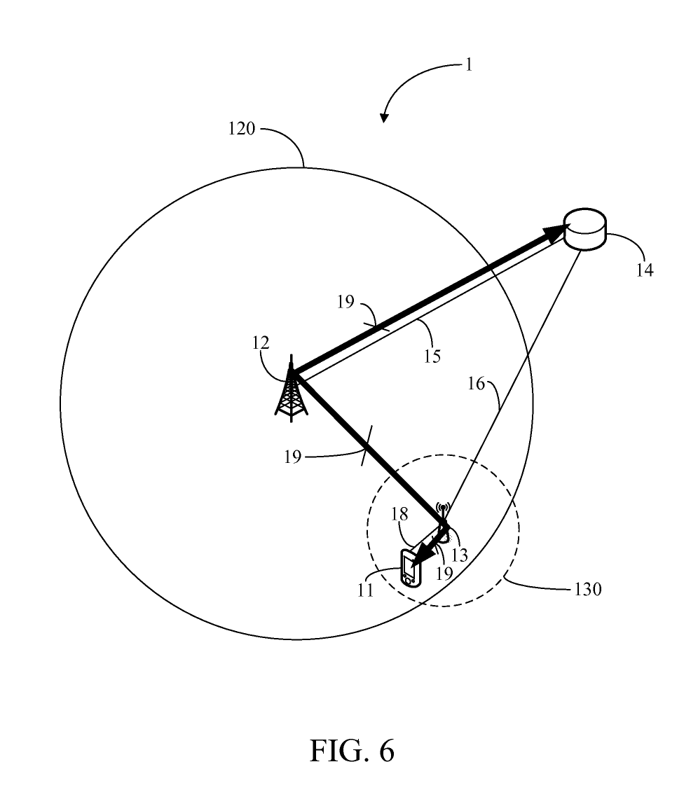

Additionally, as shown in FIG. 6, upon completion of the handover procedure, the gateway 14 might also determine, according to a network load, that the network service 19 shall be provided firstly by the WiMAX base station 12 and then by the Wi-Fi access point 13 to the Wi-Fi wireless network interface 114 of the mobile node 11. In other words, no matter which path the gateway 14 takes to provide the network service 19 to the mobile node 11 subsequent to the handover, the network service 19 to the mobile node 11 will definitely be finally provided by the Wi-Fi access point 13.

Furthermore, if the mobile node 11 attempts to handover back to the WiMAX base station 12 later, the mobile node 11 simply needs to transmit a second handover request signal 1115 to the Wi-Fi access point 13 via the Wi-Fi wireless network interface 114 thereof. After the second handover request signal 1115 is received by the Wi-Fi wireless network interface 134 of the Wi-Fi access point 13, the process module 132 of the Wi-Fi access point 13 will restore the aforesaid connection kept between the WiMAX base station 12 and the mobile node 11 according to the second handover request signal 1115 so that the network service 19 will be provided by the gateway 14 via the WiMAX base station 12 again to the WiMAX wireless network interface 113 of the mobile node 11.

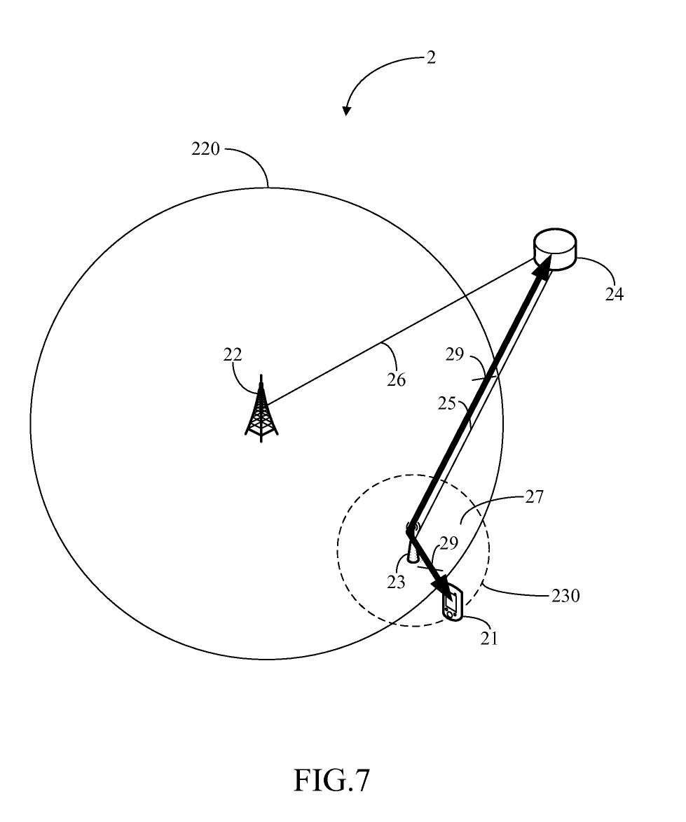

Next, before describing the second embodiment of the present invention, the environment in which the second embodiment of the present invention operates will be described first. FIG. 7 illustrates a schematic view of a heterogeneous wireless network system 2. The heterogeneous wireless network system 2 comprises a mobile node 21, a WiMAX base station 22, a Wi-Fi access point 23 and a gateway 24. The WiMAX base station 22 and Wi-Fi access point 23 are connected to the gateway 24 via a wired network 26 and a wired network 25 respectively, and can exchange messages with each other via the gateway 24. As shown in FIG. 7, the WiMAX base station 22 has a base station service area 220, the Wi-Fi access point 23 has an access point service area 230, and there is an overlap service area 27 between the base station service area 220 and the access point service area 230. The mobile node 21 is located within the access point service area 230 to receive a network service 29 provided by the gateway 24 via the Wi-Fi access point 23. Currently, the mobile node 21 is moving towards the base station service area 220.

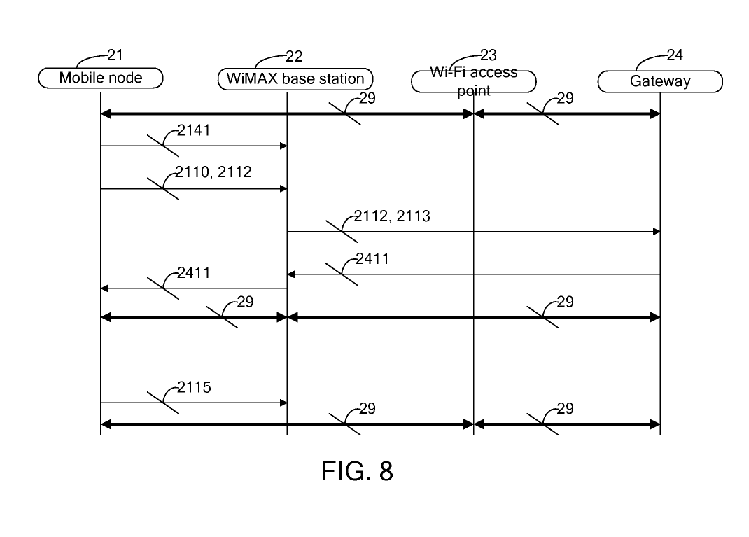

The second embodiment of the present invention is shown in FIG. 8, which is a schematic view illustrating the exchange of handover signals. As described above, the mobile node 21 is currently moving towards the base station service area 220. During this process, the mobile node 21 gradually moves away from the access point service area 230 into the base station service area 220. To ensure a certain level of communication quality during the moving process of the mobile node 21, the exchange of handover signals as shown in FIG. 8 will take place in the heterogeneous wireless network system 2 when the mobile node 21 enters the overlap service area 27.

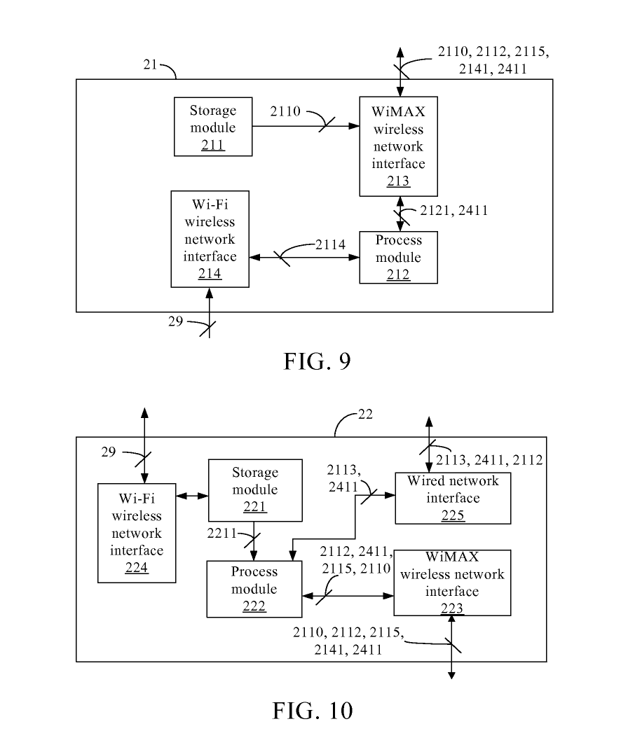

To more clearly illustrate the actions of the mobile node 21, the WiMAX base station 22, the Wi-Fi access point 23 and the gateway 24 in exchange of handover signals as shown in FIG. 8, reference is made to FIGS. 9 and 10, which illustrate schematic views of the mobile node 21 and the WiMAX base station 22 respectively. As can be seen from FIG. 9, the mobile node 21 comprises a storage module 211, a process module 212, a WiMAX wireless network interface 213 and a Wi-Fi wireless network interface 214, in which the storage module 211 is configured to store handover information 2110 related to the Wi-Fi access point 23.

As can be further seen from FIG. 10, the WiMAX base station 22 comprises a storage module 221, a process module 222, a WiMAX wireless network interface 223, a Wi-Fi wireless network interface 224 and a wired network interface 225, in which the storage module 221 is configured to store handover information 2311 related to the WiMAX base station 22. The wired network interface 225 is compatible with the wired network 26, and is adapted to be connected to the gateway 24 via the wired network 26. It should be noted that both the WiMAX wireless network interfaces 213 and 223 are compatible with IEEE 802.16, while both the Wi-Fi wireless network interface 214 and 224 are compatible with IEEE 802.11. Next, the individual modules in the mobile node 21 and the WiMAX base station 22 as well as the operations and functions of the network interfaces and the Wi-Fi access point 23 will be described in detail.

First, in reference to FIGS. 8-10, before the mobile node 21 enters the overlap service area 27, the W-Fi wireless network interface 214 of the mobile node 21 receives the network service 29 from the gateway 24 via the Wi-Fi access point 23. The storage module 211 of the mobile node 21 stores connection information 2110 related to the Wi-Fi access point 23.

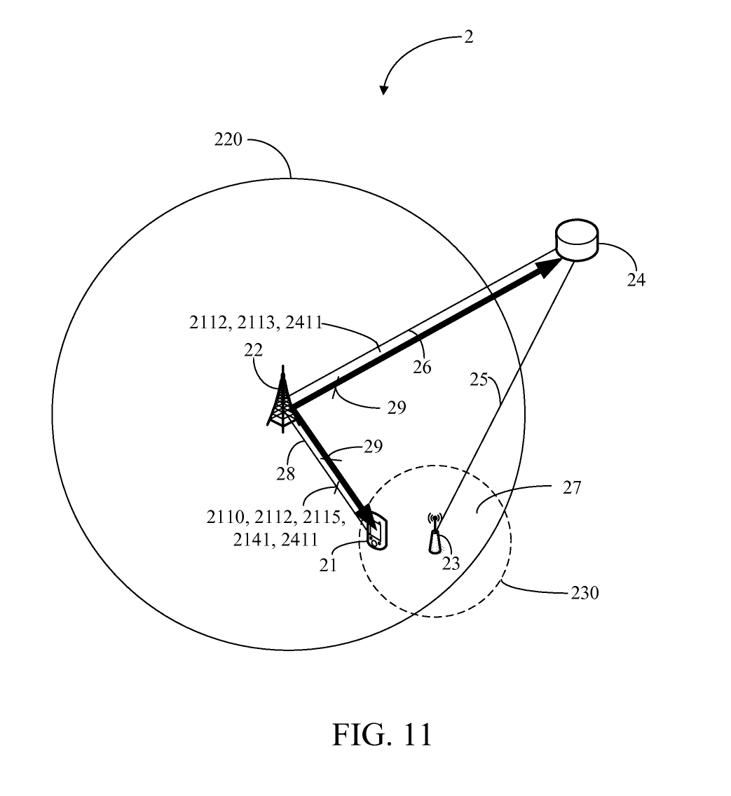

Then, as shown in FIG. 11, the mobile node 21 moves to the overlap service area 27, at which moment the process module 212 of the mobile node 21 determines that the mobile node 21 has entered the overlap service area 27 to generate a determination result 2121. According to the determination result 2121, the WiMAX wireless network interface 213 of the mobile node 21 transmits a link request signal 2141 to the WiMAX base station 22. The link request signal 2141 is received by the WiMAX wireless network interface 223 of the WiMAX base station 22, which immediately establishes a link 28 of a data link layer with the mobile node 21 according to the link request signal 2141.

Upon establishment of the link 28 of the data link layer, the mobile node 21 determines whether to be handover from the Wi-Fi access point 23 to the WiMAX base station 22 depending on the status of the surrounding environment. The method in which the mobile node 21 determines whether to be handover can be accomplished by conventional technologies and will not be further described herein. To highlight the efficacy of the present invention, it will be assumed in the following description that the mobile node 21 is going to be handover. To accomplish the handover, the WiMAX wireless network interface 213 of the mobile node 21 transmits the connection information 2110 and a first handover request signal 2112 to the WiMAX base station 22 respectively via the link 28 to inform the WiMAX base station 22 the information about the connection between the mobile node 21 and the Wi-Fi access point 23 (i.e. the connection information 2110), and the mobile node 21 is going to be handover. It should be appreciated that at this point, the mobile node 21 still receives the network service 29 via the Wi-Fi access point 23 instead of a network service interruption due to the establishment of the link 28 with the WiMAX base station 22.

After being transmitted by the mobile node 21, the connection information 2110 and the first handover request signal 2112 are received by the WiMAX wireless network interface 223 of the WiMAX base station 22 via the link 28, and according to the first handover request signal 2112, the process module 222 of the WiMAX base station 22 composes the connection information 2110 and the handover information 2311 stored in the storage module 221 to generate composition information 2113. Then, the first handover request signal 2112 and the composition information 2113 are transmitted together to the gateway 24 by the wired network module 225 of the WiMAX base station 22 via the wired network 26.

After the gateway 24 receives the first handover request signal 2112 and the composition information 2113, a handover procedure can be performed jointly by the gateway 24, the Wi-Fi wireless network interface 224 of the WiMAX base station 22 and the Wi-Fi access point 23 according to the first handover request signal 2112, the composition information 2113 and a media independent handover protocol to handover the mobile node 21 from the Wi-Fi access point 23 to the WiMAX base station 22. Consequently, upon the completion of the handover procedure, the network service 29 can be provided to the mobile node 21 by the gateway 24 via the WiMAX wireless network interface 223 of the WiMAX base station 22. This handover procedure can be accomplished by a conventional technology and, thus, will not be further described herein.

Upon completion of the handover procedure, a handover response signal 2411 is transmitted by the gateway 24 to the WiMAX base station 22 via the wired network 26 so that the WiMAX base station 22 is assured that the gateway 24 agrees to perform and has already performed the handover procedure. Then, a frame synchronization procedure is performed between the WiMAX base station 22 and the Wi-Fi access point 23 via the gateway 24. In more detail, in the frame synchronization procedure, the service is synchronized in the WiMAX base station 22 according to the service provided by the Wi-Fi access point 23 to the mobile node 21 so that after synchronization, the Wi-Fi access point 23 can be replaced by the WiMAX base station 22 without asynchronization of the network service 29 caused by the handover.

Upon completion of the frame synchronization, the process module 222 of the WiMAX base station 22 still keeps a connection (not shown) between the Wi-Fi access point 23 and the mobile node 21 according to the handover response signal 2411, and the WiMAX wireless network interface 223 of the WiMAX base station 22 transmits the handover response signal 2411 to the mobile node 21. The handover response signal 2411 is received by the WiMAX wireless network interface 213 of the mobile node 21 which then, according to the handover response signal 2411, receives the network service 29 via the WiMAX base station 22 as shown in FIG. 11. Furthermore, according to the handover response signal 2411, the process module 212 of the mobile node 21 determines that the aforesaid handover procedure has been completed to generate a sleep signal 2114. Then, the Wi-Fi wireless network interface 214 of the mobile node 21 enters a sleep mode according to the sleep signal 2114 to reduce power consumption of the Wi-Fi wireless network interface 214.

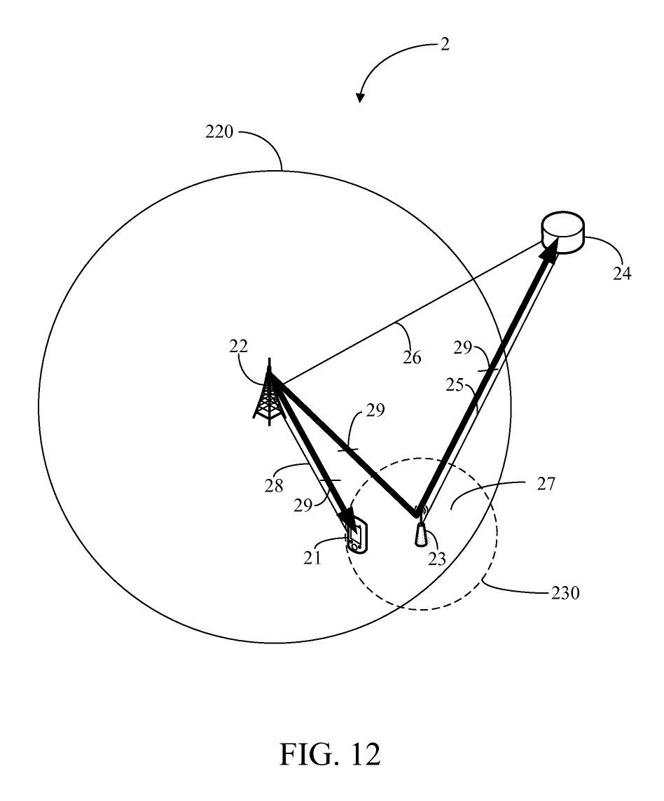

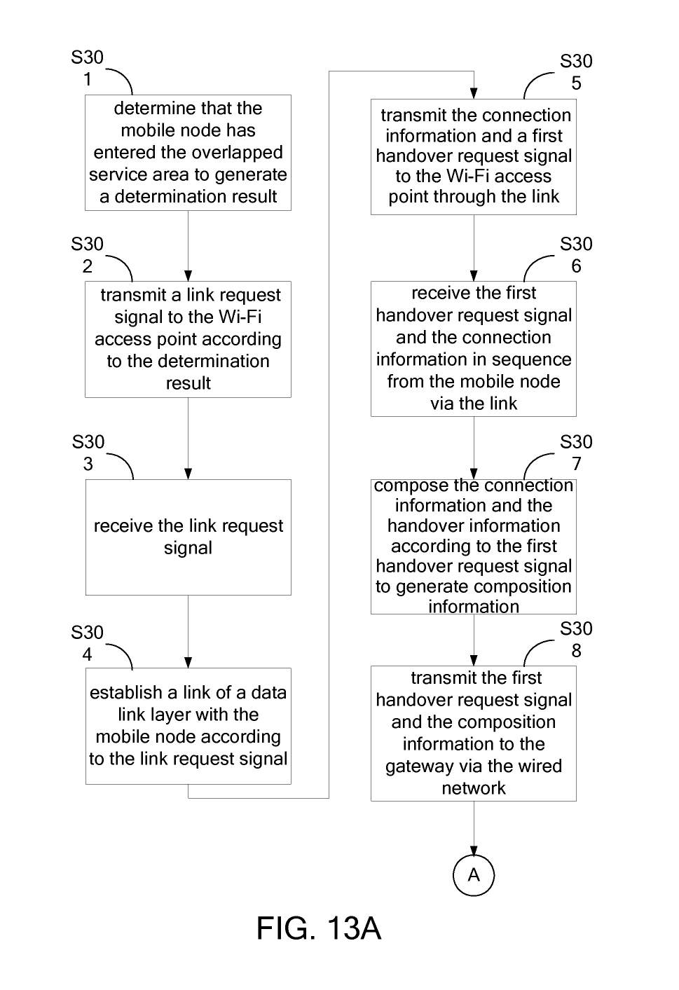

Additionally, as shown in FIG. 12, upon completion of the handover procedure, the gateway 24 might also determine according to a network load that the network 29 shall be provided firstly by the Wi-Fi access point 23 and then by the WiMAX base station 22 to the WiMAX wireless network interface 213 of the mobile node 21. In other words, no matter which path the gateway 24 takes to provide the network service 29 to the mobile node 21 subsequent to the handover, the network service 29 to the mobile node 21 will definitely be finally provided by the WiMAX base station 22.

Furthermore, if the mobile node 21 is going to be handover back to the Wi-Fi access point 23 later, the mobile node 21 simply needs to transmit a second handover request signal 2115 to the WiMAX base station 22 via the WiMAX wireless network interface 213 thereof. After the second handover request signal 2115 is received by the WiMAX wireless network interface 223 of the WiMAX base station 22, the process module 222 of the WiMAX base station 22 will restore the aforesaid connection kept between the Wi-Fi access point 23 and the mobile node 21 according to the second handover request signal 2115 so that the network service 29 will be provided by the gateway 24 via the Wi-Fi access point 23 again to the Wi-Fi wireless network interface 214 of the mobile node 21.

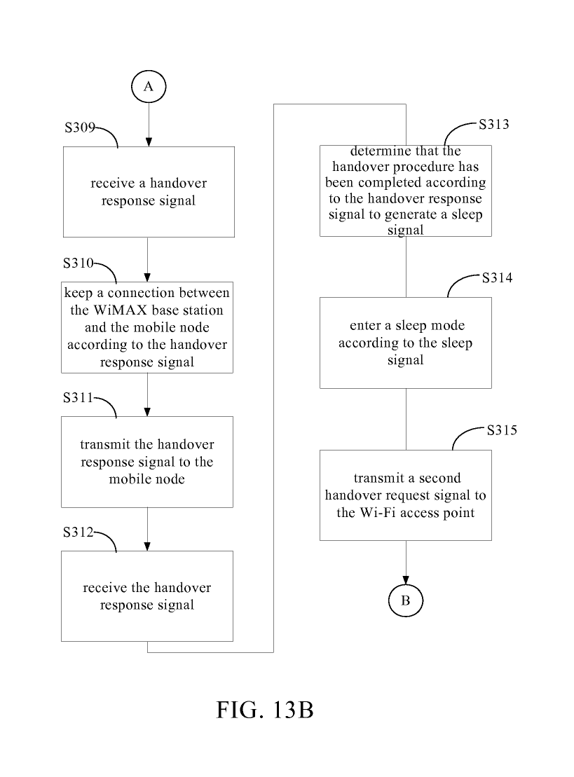

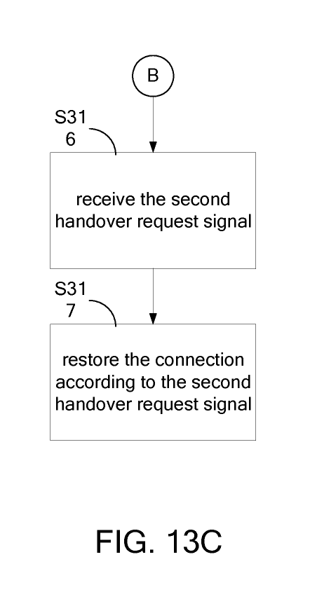

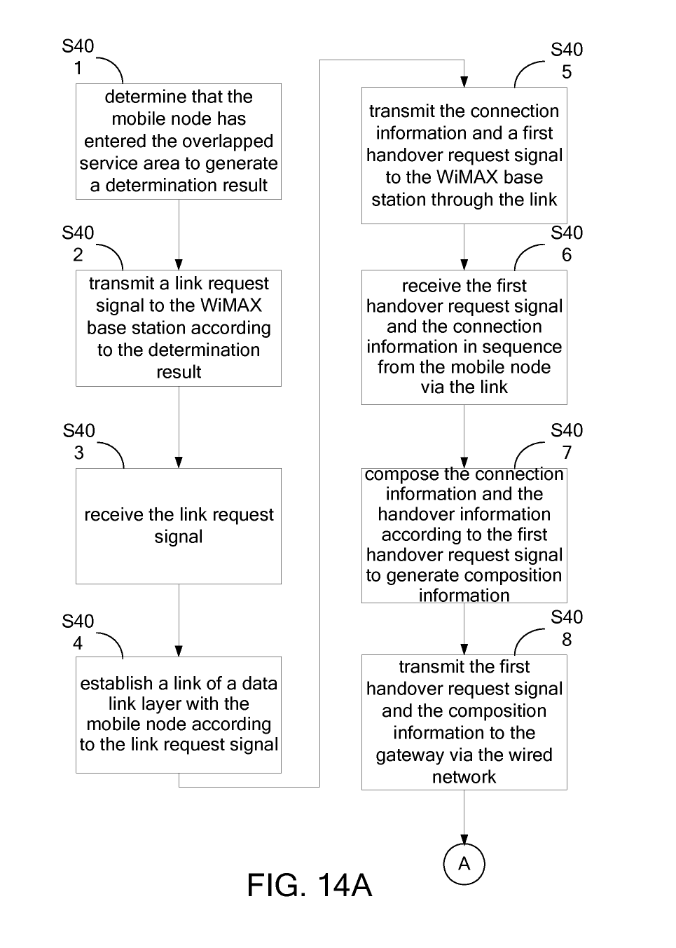

A third embodiment of the present invention is shown in FIGS. 13A-13C, which are flowcharts of a handover method for the heterogeneous wireless network system of the first embodiment. The heterogeneous wireless network system comprises a mobile node, a gateway, a WiMAX wireless network and a Wi-Fi wireless network. The WiMAX wireless network comprises a WiMAX base station. The Wi-Fi wireless network comprises a Wi-Fi access point. The mobile node comprises a process module, a storage module, a WiMAX wireless network interface and a Wi-Fi wireless network interface. The Wi-Fi access point comprises a process module, a storage module, a WiMAX wireless network interface, a Wi-Fi wireless network interface and a wired network interface. The Wi-Fi access point is adapted to be connected to the gateway via a wired network via the wired network interface.

Furthermore, the WiMAX base station is adapted to exchange messages with the Wi-Fi access point via the gateway. There is an overlap service area between the WiMAX base station and the Wi-Fi access point. The mobile node is currently receiving a network service provided by the gateway via the WiMAX base station. The storage module of the mobile node stores connection information related to the WiMAX base station, while the storage module of the Wi-Fi access point stores handover information. The handover method comprises the following steps.

First, in reference to FIG. 13A, when the mobile node moves to the overlap service area, step S301 is executed to enable the process module to determine that the mobile node has entered the overlap service area to generate a determination result. Then, step S302 is executed to enable the Wi-Fi wireless network interface of the mobile node to, according to the determination result, transmit a link request signal to the Wi-Fi access point. Next, step S303 is executed to enable the Wi-Fi wireless network interface of the Wi-Fi access point to receive the link request signal, and step S304 is executed to establish a link of a data link layer with the mobile node according to the link request signal. Then, step S305 is executed to enable the Wi-Fi wireless network interface of the mobile node to transmit the connection information and a first handover request signal to the Wi-Fi access point via the link.

Afterwards, step S306 is executed to enable the Wi-Fi wireless network interface of the Wi-Fi access point to receive the first handover request signal and the connection information in sequence from the mobile node via the link, and step S307 is executed to enable the process module of the Wi-Fi access point to compose the connection information and the handover information according to the first handover request signal to generate composition information. Then, step S308 is executed to enable the wired network interface of the Wi-Fi access point to transmit the first handover request signal and the composition information to the gateway via the wired network so that the gateway, the WiMAX wireless network interface and the WiMAX base station jointly perform a handover procedure according to the first handover request signal, the composition information and a media independent handover protocol.

In reference to FIG. 13B, after completion of the handover procedure, the gateway further transmits a handover response signal, and step S309 is executed to enable the wired network interface of the Wi-Fi access point to receive the handover response signal. Then, step S310 is executed to enable the process module of the Wi-Fi access point to keep a connection between the WiMAX base station and the mobile node according to the handover response signal. Step S311 is executed to enable the Wi-Fi wireless network interface of the Wi-Fi access point to transmit the handover response signal to the mobile node. Subsequently, step S312 is executed to enable the Wi-Fi wireless network interface of the mobile node to receive the handover response signal, and step S313 is executed to enable the process module of the mobile node to determine that the handover procedure has been completed according to the handover response signal to generate a sleep signal. Then, step S314 is executed to enable the WiMAX wireless network interface of the mobile node to enter a sleep mode according to the sleep signal.

Afterwards, if the mobile node is going to be handover back to the WiMAX base station, step S315 is executed to enable the Wi-Fi wireless network interface of the mobile node to transmit a second handover request signal to the Wi-Fi access point. In reference to FIG. 13C, step S316 is executed to enable the Wi-Fi wireless network interface of the Wi-Fi access point to receive the second handover request signal. Then, step S317 is executed to enable the process module of the Wi-Fi access point to restore the connection according to the second handover request signal so that the network service may be provided by the gateway to the mobile node via the WiMAX base station again.

In addition to the aforesaid steps, the third embodiment can also execute all the operations and functions set forth in the first embodiment. The method in which the third embodiment executes these operations and functions will be readily appreciated by those of ordinary skill in the art based on the explanation of the first embodiment, and thus will not be further described herein.

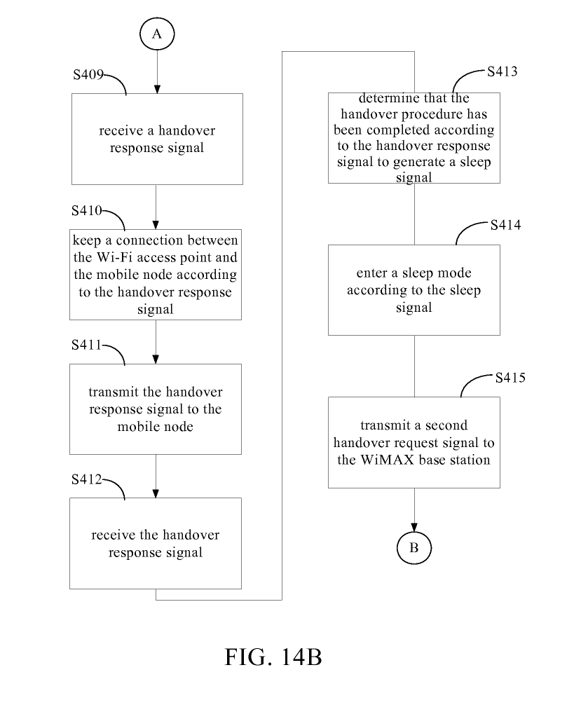

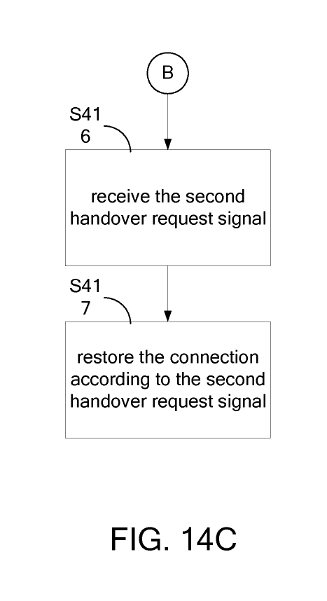

A fourth embodiment of the present invention is shown in FIGS. 14A-14C, which are flowcharts of a handover method for the heterogeneous wireless network system of the second embodiment. The heterogeneous wireless network system comprises a mobile node, a gateway, a WiMAX wireless network and a Wi-Fi wireless network. The WiMAX wireless network comprises a WiMAX base station. The Wi-Fi wireless network comprises a Wi-Fi access point. The mobile node comprises a process module, a storage module, a WiMAX wireless network interface and a Wi-Fi wireless network interface. The WiMAX base station comprises a process module, a storage module, a WiMAX wireless network interface, a Wi-Fi wireless network interface and a wired network interface. The WiMAX base station is adapted to be connected to the gateway via a wired network via the wired network interface.

Furthermore, the WiMAX base station is adapted to exchange messages with the Wi-Fi access point via the gateway. There is an overlap service area between the WiMAX base station and the Wi-Fi access point. The mobile node is currently receiving a network service provided by the gateway via the Wi-Fi access point. The storage module of the mobile node stores connection information related to the Wi-Fi access point, while the storage module of the WiMAX base station stores handover information. The handover method comprises the following steps.

First, in reference to FIG. 14A, when the mobile node moves into the overlap service area, step S401 is executed to enable the process module to determine that the mobile node has entered the overlap service area to generate a determination result. Then, step S402 is executed to enable the WiMAX wireless network interface of the mobile node to, according to the determination result, transmit a link request signal to the WiMAX base station. Next, step S403 is executed to enable the WiMAX wireless network interface of the WiMAX base station to receive the link request signal, and step S404 is executed to establish a link of a data link layer with the mobile node according to the link request signal. Then step S405 is executed to enable the WiMAX wireless network interface of the mobile node to transmit the connection information and a first handover request signal to the WiMAX base station via the link.

Afterwards, step S406 is executed to enable the WiMAX wireless network interface of the WiMAX base station to receive the first handover request signal and the connection information in sequence from the mobile node via the link, and step S407 is executed to enable the process module of the WiMAX base station to compose the connection information and the handover information according to the first handover request signal to generate composition information. Then, step S408 is executed to enable the wired network interface of the WiMAX base station to transmit the first handover request signal and the composition information to the gateway via the wired network so that the gateway, the Wi-Fi wireless network interface and the Wi-Fi access point jointly perform a handover procedure according to the first handover request signal, the composition information and a media independent handover protocol.

In reference to FIG. 14B, after completion of the handover procedure, the gateway further transmits a handover response signal, and step S409 is executed to enable the wired network interface of the WiMAX base station to receive the handover response signal. Then, step S410 is executed to enable the process module of the WiMAX base station to keep a connection between the Wi-Fi access point and the mobile node according to the handover response signal. Step S411 is executed to enable the WiMAX wireless network interface of the WiMAX base station to transmit the handover response signal to the mobile node. Subsequently, step S412 is executed to enable the WiMAX wireless network interface of the mobile node to receive the handover response signal, and step S413 is executed to enable the process module of the mobile node to determine that the handover procedure has been completed according to the handover response signal to generate a sleep signal. Then, step S414 is executed to enable the Wi-Fi wireless network interface of the mobile node to enter a sleep mode according to the sleep signal.

Afterwards, if the mobile node is going to be handover back to the Wi-Fi access point, step S415 is executed to enable the WiMAX wireless network interface of the mobile node to transmit a second handover request signal to the WiMAX base station. In reference to FIG. 14C, step S416 is executed to enable the WiMAX wireless network interface of the WiMAX base station to receive the second handover request signal. Then, step S417 is executed to enable the process module of the WiMAX base station to restore the connection according to the second handover request signal so that the network service may be provided by the gateway to the mobile node via the Wi-Fi access point again.

In addition to the aforesaid steps, the fourth embodiment can also execute all the operations and functions set forth in the second embodiment. The method in which the fourth embodiment executes these operations and functions will be readily appreciated by those of ordinary skill in the art based on the explanation of the second embodiment, and thus will not be further described herein.

According to the above descriptions, when the mobile node of the present invention enters the overlap service area between the WiMAX network and the Wi-Fi network from the WiMAX network service area, a connection is established immediately between the mobile node and the Wi-Fi access point so that the gateway hands over the mobile node from the WiMAX base station to the Wi-Fi access point without interrupting the original service. Furthermore, the connection between the mobile node and the WiMAX base station is still kept by the Wi-Fi access point so that once the mobile node attempts to switch back to the WiMAX network, it may switch back to the WiMAX network promptly without interruption to the network service. Similarly, when the mobile node attempts to switch from the Wi-Fi network to the WiMAX network, a handover procedure can also be performed as described above. In this way, the defects of the prior art that network services have to be interrupted for handover of the mobile node is overcome effectively, thereby improving the quality of network services remarkably.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile node for use in a heterogeneous wireless network system, the heterogeneous wireless network system comprising a gateway, a Wi-Fi wireless network and a World Interoperability for Microwave Access (WiMAX) wireless network, the Wi-Fi wireless network comprising a Wi-Fi access point, the WiMAX wireless network comprising a WiMAX base station, the WiMAX base station being adapted to exchange messages with the Wi-Fi access point via the gateway, the WiMAX base station and the Wi-Fi access point having an overlap service area, the mobile node being currently receiving a network service provided by the gateway via the WiMAX base station, the mobile node comprising:
a storage module, being configured to store connection information related to the WiMAX base station;
a WiMAX wireless network interface, being configured to receive the network service;
a Wi-Fi wireless network interface; and
a process module, being configured to determine that the mobile node has entered the overlap service area to generate a determination result;
wherein the Wi-Fi wireless network interface is configured to, according to the determination result, transmit a link request signal to the Wi-Fi access point to establish a link of a data link layer with the Wi-Fi access point immediately and transmit the connection information and a first handover request signal to the Wi-Fi access point via the link, the WiMAX base station, the Wi-Fi access point and the gateway are adapted to jointly perform a handover procedure according to the connection information, the first handover request signal and a media independent handover protocol so that the network service is provided by the gateway to the mobile node via the Wi-Fi access point, and the Wi-Fi wireless network interface is further configured to receive the network service in place of the WiMAX wireless network interface.

2. The mobile node as claimed in claim 1, wherein the gateway is further configured to transmit a handover response signal via the Wi-Fi access point after completion of the handover procedure, the Wi-Fi wireless network interface is further configured to receive the handover response signal, the process module is further configured to determine that the handover procedure has been completed according to the handover response signal to generate a sleep signal, and the WiMAX wireless network interface is further configured to enter a sleep mode according to the sleep signal, the Wi-Fi access point is configured to keep a connection between the WiMAX base station and the mobile node according to the handover response signal, the Wi-Fi wireless network interface is further configured to transmit a second handover request signal to the Wi-Fi access point, and the Wi-Fi access point is adapted to restore the connection according to the second handover request signal so that the gateway provides the network service to the WiMAX wireless network interface of the mobile node via the WiMAX base station again.

3. A handover method for a mobile node in a heterogeneous wireless network system, the mobile node comprising a process module, a WiMAX wireless network interface, a Wi-Fi wireless network interface and a storage module, the heterogeneous wireless network system comprising a gateway, a WiMAX wireless network and a Wi-Fi wireless network, the WiMAX wireless network comprising a WiMAX base station, the Wi-Fi wireless network comprising a Wi-Fi access point, the WiMAX base station being adapted to exchange messages with the Wi-Fi access point via the gateway, the WiMAX base station and the Wi-Fi access point having an overlap service area together, the mobile node being currently receiving a network service provided by the gateway via the WiMAX base station, the storage module of the mobile node storing connection information related to the WiMAX base station, the handover method comprising the following steps of:
(a) enabling the process module to determine that the mobile node has entered the overlap service area to generate a determination result;
(b) enabling the Wi-Fi wireless network interface to, according to the determination result, transmit a link request signal to the Wi-Fi access point to establish a link of a data link layer with the Wi-Fi access point immediately; and
(c) enabling the Wi-Fi wireless network interface to transmit the connection information and a first handover request signal to the Wi-Fi access point via the link;
wherein the WiMAX base station, the Wi-Fi access point and the gateway are adapted to jointly perform a handover procedure according to the connection information, the first handover request signal and a media independent handover protocol so that the network service is provided by the gateway to the mobile node via the Wi-Fi access point.

4. The handover method as claimed in claim 3, wherein the gateway further transmits a handover response signal to the mobile node via the Wi-Fi access point after completion of the handover procedure, the Wi-Fi access point is configured to keep a connection between the WiMAX base station and the mobile node according to the handover response signal, and the handover method further comprises the following steps of:
(d) enabling the Wi-Fi wireless network interface to receive the handover response signal;
(e) enabling the process module to determine that the handover procedure has been completed according to the handover response signal to generate a sleep signal;
(f) enabling the WiMAX wireless network interface to enter a sleep mode according to the sleep signal; and
(g) enabling the Wi-Fi wireless network interface to transmit a second handover request signal to the Wi-Fi access point, wherein the Wi-Fi access point is adapted to restore the connection according to the second handover request signal so that the gateway provides the network service to the WiMAX wireless network interface of the mobile node via the WiMAX base station again.

5. A mobile node for use in a heterogeneous wireless network system, the heterogeneous wireless network system comprising a gateway, a Wi-Fi wireless network and a WiMAX wireless network, the Wi-Fi wireless network comprising a Wi-Fi access point, the WiMAX wireless network comprising a WiMAX base station, the WiMAX base station being adapted to exchange messages with the Wi-Fi access point via the gateway, the WiMAX base station and the Wi-Fi access point having an overlap service area together, the mobile node being currently receiving a network service provided by the gateway via the Wi-Fi access point, the mobile node comprising:
a storage module, being configured to store connection information related to the Wi-Fi access point;
a WiMAX wireless network interface;
a Wi-Fi wireless network interface, being configured to receive the network service; and
a process module, being configured to determine that the mobile node has entered the overlap service area to generate a determination result;
wherein the WiMAX wireless network interface is configured to, according to the determination result, transmit a link request signal to the WiMAX base station to establish a link of a data link layer with the WiMAX base station immediately and transmit the connection information and a first handover request signal to the WiMAX base station via the link, the WiMAX base station, the Wi-Fi access point and the gateway are adapted to jointly perform a handover procedure according to the connection information, the first handover request signal and a media independent handover protocol so that the network service is provided by the gateway via the WiMAX base station, and the WiMAX wireless network interface is further configured to receive the network service in place of the Wi-Fi wireless network interface.

6. The mobile node as claimed in claim 5, wherein the gateway is further configured to transmit a handover response signal via the WiMAX base station after completion of the handover procedure, the WiMAX wireless network interface is further configured to receive the handover response signal, the process module is further configured to determine that the handover procedure has been completed according to the handover response signal to generate a sleep signal, and the Wi-Fi wireless network interface is further configured to enter a sleep mode according to the sleep signal, the WiMAX base station is configured to keep a connection between the Wi-Fi access point and the mobile node according to the handover response signal, the WiMAX wireless network interface is further configured to transmit a second handover request signal to the WiMAX base station, and the WiMAX base station is adapted to restore the connection according to the second handover request signal so that the gateway provides the network service to the Wi-Fi wireless network interface of the mobile node via the Wi-Fi access point again.

7. A handover method for a mobile node in a heterogeneous wireless network system, the mobile node comprising a process module, a WiMAX wireless network interface, a Wi-Fi wireless network interface and a storage module, the heterogeneous wireless network system comprising a gateway, a WiMAX wireless network and a Wi-Fi wireless network, the WiMAX wireless network comprising a WiMAX base station, the Wi-Fi wireless network comprising a Wi-Fi access point, the WiMAX base station being adapted to exchange messages with the Wi-Fi access point via the gateway, the WiMAX base station and the Wi-Fi access point having an overlap service area together, the mobile node being currently receiving a network service provided by the gateway via the Wi-Fi access point, the storage module of the mobile node storing connection information related to the Wi-Fi access point, the handover method comprising the following steps of:
(a) enabling the process module to determine that the mobile node has entered the overlap service area to generate a determination result;
(b) enabling the WiMAX wireless network interface to, according to the determination result, transmit a link request signal to the WiMAX base station to establish a link of a data link layer with the WiMAX base station immediately; and
(c) enabling the WiMAX wireless network interface to transmit the connection information and a first handover request signal respectively to the WiMAX base station via the link, wherein the WiMAX base station, the Wi-Fi access point and the gateway are adapted to jointly perform a handover procedure according to the connection information, the first handover request signal and a media independent handover protocol so that the network service is provided by the gateway to the mobile node via the WiMAX base station.

8. The handover method as claimed in claim 7, wherein the gateway further transmits a handover response signal via the WiMAX base station after completion of the handover procedure, the WiMAX base station is configured to keep a connection between the Wi-Fi access point and the mobile node according to the handover response signal and the handover method further comprises the following steps of:
(d) enabling the WiMAX wireless network interface to receive the handover response signal;
(e) enabling the process module to determine that the handover procedure has been completed according to the handover response signal to generate a sleep signal;
(f) enabling the Wi-Fi wireless network interface to enter a sleep mode according to the sleep signal; and
(g) enabling the WiMAX wireless network interface to transmit a second handover request signal to the WiMAX base station, and the WiMAX base station is adapted to restore the connection according to the second handover request signal so that the gateway provides the network service to the mobile node via the Wi-Fi access point again.

9. A Wi-Fi access point for use in a heterogeneous wireless network system, the heterogeneous wireless network system comprising a mobile node, a gateway, a Wi-Fi wireless network and a WiMAX wireless network, the Wi-Fi wireless network comprising the Wi-Fi access point, the WiMAX wireless network comprising a WiMAX base station, the Wi-Fi access point being linked to the gateway via a wired network, the WiMAX base station being adapted to exchange messages with the Wi-Fi access point via the gateway, the WiMAX base station and the Wi-Fi access point having an overlap service area together, the mobile node being currently receiving a network service provided by the gateway via the WiMAX base station, the mobile node transmitting a link request signal, connection information related to the WiMAX base station and a first handover request signal in sequence while entering the overlap service area, the Wi-Fi access point comprising:
a storage module, being configured to store handover information related to the Wi-Fi access point;
a WiMAX wireless network interface;
a Wi-Fi wireless network interface, being configured to receive the link request signal, establish a link of a data link layer with the mobile node according to the link request signal, and receive the connection information and the first handover request signal in sequence via the link;
a wired network interface, being compatible with the wired network and configured to connect to the gateway via the wired network; and
a process module, being configured to compose the connection information and the handover information according to the first handover request signal to generate composition information;
wherein the wired network interface is further configured to transmit the first handover request signal and the composition information to the gateway via the wired network so that the gateway, the WiMAX wireless network interface and the WiMAX base station jointly perform a handover procedure according to the first handover request signal, the composition information and a media independent handover protocol, and the network service is provided by the gateway to the mobile node via the Wi-Fi wireless network interface of the Wi-Fi access point after completion of the handover procedure.

10. The Wi-Fi access point as claimed in claim 9, wherein the gateway is further configured to transmit a handover response signal after completion of the handover procedure, the wired network interface is further configured to receive the handover response signal, the Wi-Fi wireless network interface is further configured to transmit the handover response signal to the mobile node, and the process module is configured to keep a connection between the WiMAX base station and the mobile node according to the handover response signal, the mobile node transmits a second handover request signal, the Wi-Fi wireless network interface is configured to receive the second handover request signal, and the process module is adapted to restore the connection according to the second handover request signal so that the gateway provides the network service to the mobile node via the WiMAX base station again.

11. A handover method for use in a Wi-Fi access point, the Wi-Fi access point being adapted for use in a heterogeneous wireless network system, the Wi-Fi access point comprising a storage module, a WiMAX wireless network interface, a Wi-Fi wireless network interface, a wired network interface and a process module, the heterogeneous wireless network system comprising a mobile node, a gateway, a Wi-Fi wireless network and a WiMAX wireless network, the Wi-Fi wireless network comprising the Wi-Fi access point, the WiMAX wireless network comprising a WiMAX base station, the wired network interface of the Wi-Fi access point being linked to the gateway via a wired network, the WiMAX base station being adapted to exchange messages with the Wi-Fi access point via the gateway, the WiMAX base station and the Wi-Fi access point having an overlap service area, the storage module storing handover information related to the Wi-Fi access point, the mobile node being currently receiving a network service provided by the gateway via the WiMAX base station, the mobile node transmitting a link request signal, connection information related to the WiMAX base station and a first handover request signal in sequence while entering the overlap service area, the handover method comprising the following steps of:
(a) enabling the Wi-Fi wireless network interface to receive the link request signal;
(b) enabling the Wi-Fi wireless network interface to establish a link of a data link layer with the mobile node according to the link request signal;
(c) enabling the Wi-Fi wireless network interface to receive the first handover request signal and the connection information in sequence from the mobile node via the link;
(d) enabling the process module to compose the connection information and the handover information according to the first handover request signal to generate composition information; and
(e) enabling the wired network interface to transmit the first handover request signal and the composition information to the gateway via the wired network so that the gateway, the WiMAX wireless network interface and the WiMAX base station jointly perform a handover procedure according to the first handover request signal, the composition information and a media independent handover protocol, wherein the network service is provided by the gateway to the mobile node via the Wi-Fi wireless network interface of the Wi-Fi access point after completion of the handover procedure.

12. The handover method as claimed in claim 11, wherein the gateway is further configured to transmit a handover response signal after completion of the handover procedure, the mobile node transmits a second handover request signal, and the handover method further comprises the following steps of:
(f) enabling the wired network interface to receive the handover response signal;
(g) enabling the Wi-Fi wireless network interface to transmit the handover response signal to the mobile node;
(h) enabling the process module to keep a connection between the WiMAX base station and the mobile node according to the handover response signal;
(i) enabling the Wi-Fi wireless network interface to receive the second handover request signal; and
(j) enabling the process module to restore the connection according to the second handover request signal so that the gateway provides the network service to the mobile node via the WiMAX base station again.

13. A WiMAX base station for use in a heterogeneous wireless network system, the heterogeneous wireless network system comprising a mobile node, a gateway, a Wi-Fi wireless network and a WiMAX wireless network, the Wi-Fi wireless network comprising a Wi-Fi access point, the WiMAX wireless network comprising the WiMAX base station, the WiMAX base station being connected to the gateway via a wired network, the Wi-Fi access point being adapted to exchange messages with the WiMAX base station via the gateway, the WiMAX base station and the Wi-Fi access point having an overlap service area together, the mobile node being currently receiving a network service provided by the gateway via the Wi-Fi access point, the mobile node transmitting a link request signal, connection information related to the Wi-Fi access point and a first handover request signal in sequence while entering the overlap service area, the WiMAX base station comprising:
a storage module, being configured to store handover information related to the WiMAX base station;
a WiMAX wireless network interface, being configured to receive the link request signal, establish a link of a data link layer with the mobile node according to the link request signal, and receive the connection information and the first handover request signal in sequence via the link;
a Wi-Fi wireless network interface;
a wired network interface, being compatible with the wired network and connected to the gateway via the wired network; and
a process module, being configured to compose the connection information and the handover information according to the first handover request signal to generate composition information;
wherein the wired network interface is further configured to transmit the first handover request signal and the composition information to the gateway via the wired network so that the gateway, the Wi-Fi wireless network interface and the Wi-Fi access point jointly perform a handover procedure according to the first handover request signal, the composition information and a media independent handover protocol, and the network service is provided by the gateway to the mobile node via the WiMAX wireless network interface of the WiMAX base station after completion of the handover procedure.

14. The WiMAX base station as claimed in claim 13, wherein the gateway is further configured to transmit a handover response signal after completion of the handover procedure, the wired network interface is further configured to receive the handover response signal, the WiMAX wireless network interface is further configured to transmit the handover response signal to the mobile node, and the process module is configured to keep a connection between the Wi-Fi access point and the mobile node according to the handover response signal, the mobile node transmits a second handover request signal, the WiMAX wireless network interface is configured to receive the second handover request signal, and the process module is adapted to restore the connection according to the second handover request signal so that the gateway provides the network service to the mobile node via the Wi-Fi access point again.

15. A handover method for use in a WiMAX base station, the WiMAX base station being adapted for use in a heterogeneous wireless network system, the WiMAX base station comprising a storage module, a WiMAX wireless network interface, a Wi-Fi wireless network interface, a wired network interface and a process module, the storage module storing handover information related to the WiMAX base station, the heterogeneous wireless network system comprising a mobile node, a Wi-Fi access point and a gateway, the wired network interface of the WiMAX base station being connected to the gateway via a wired network, the Wi-Fi access point and the WiMAX base station having an overlap service area together, the mobile node being currently receiving a network service provided by the gateway via the Wi-Fi access point, the mobile node transmitting a link request signal, connection information related to the Wi-Fi access point and a first handover request signal in sequence while entering the overlap service area, the handover method comprising the following steps of:
(a) enabling the WiMAX wireless network interface to receive the link request signal;
(b) enabling the WiMAX wireless network interface to establish a link of a data link layer with the mobile node according to the link request signal;
(c) enabling the WiMAX wireless network interface to receive the first handover request signal and the connection information in sequence from the mobile node via the link;
(d) enabling the process module to compose the connection information and the handover information according to the first handover request signal to generate composition information; and
(e) enabling the wired network interface to transmit the first handover request signal and the composition information to the gateway via the wired network so that the gateway, the Wi-Fi wireless network interface and the Wi-Fi access point jointly perform a handover procedure according to the first handover request signal, the composition information and a media independent handover protocol, and the network service is provided by the gateway to the mobile node via the WiMAX wireless network interface of the WiMAX base stationafter completion of the handover procedure.

16. The handover method as claimed in claim 15, wherein the gateway is further configured to transmit a handover response signal after completion of the handover procedure, the mobile node transmits a second handover request signal, and the handover method further comprises the following steps of:
(f) enabling the wired network interface to receive the handover response signal;
(g) enabling the WiMAX wireless network interface to transmit the handover response signal to the mobile node;
(h) enabling the process module to keep a connection between the Wi-Fi access point and the mobile node according to the handover response signal;
(i) enabling the WiMAX wireless network interface to receive the second handover request signal; and
(j) enabling the process module to restore the connection according to the second handover request signal so that the gateway provides the network service to the mobile node via the Wi-Fi access point again.
